(19) United States
(12) Patent Application Publication
(10) Pub. No.: US 2005/0021707 A1
(43) Pub. Date: Jan. 27, 2005

(54) Method for operating a communications network

(76) Inventor: Oliver Fendt, Munchen (DE)

Correspondence Address: Siemens Corporation;Intellectual Property Department, 170 Wood Avenue South, Iselin, NJ, 08830, US

(21) Appl. No.: 10/499,744

(22) PCT Filed: Dec. 4, 2002
(86) PCT No.: PCT/EP02/13750

(30) Foreign Application Priority Data
Dec. 19, 2001 (EP) 01130335.1

(51) Int. Cl. G06F 15/173

(52) U.S. Cl. 709/223

(57) ABSTRACT

In order to operate a communications network that comprises at least one network management system and a plurality of network components, management data are exchanged between the at least one network management system and at least one network component via a communications infrastructure that is provided by a web service, thereby creating open interfaces between the network components, and the at least one network management system. Via these interfaces, a flexibly enlargeable, reliable and producer-independent management of a communications network, comprising inter alia also different network management systems, is facilitated.

### CROSS REFERENCE TO RELATED APPLICATIONS

This application is the US National Stage of International Application No. PCT/EP02/13750 filed Dec. 4, 2002 and claims the benefit thereof. The International Application claims the benefit of European application No. 01130335.1 filed Dec. 19, 2001, both of the applications are incorporated by reference herein in their entirety.

### FIELD OF INVENTION

The invention relates to a method for operating a communications network which features at least one network management system and a number of network components and in which management data is exchanged between the at least one network management system and at least one of the network components.

### BACKGROUND OF INVENTION

The globalization and deregulation of the telecommunications market is leading to a high level of competitive pressure on a large number of telecommunications providers. The telecommunications providers therefore see it as desirable to be able to offer more attractive IN services as well as to keep the ongoing costs of operating a telecommunications network as low as possible. A significant element of the ongoing costs arises in the expenditure on the at least one network management system. These types of network management system are designed to meet different requirements. These include the capability for rapid expansion, a high level of flexibility and easy integration of further management systems from a wide variety of other suppliers. In addition robust, easily scalable and platform-independent realization of network management functions is desirable.

Because of the historical development of the telecommunications market network management systems currently implemented are strongly focused, complex to operate and maintain, can only be expanded with considerable effort and offer greatly restricted scalability. Essentially the three known main areas on which current network management systems focus are as follows: Technology, manufacturer and traffic-related areas.

The focus on technology relates to the technologies provided for the various areas of application within a telecommunications network of a network management system, for example the access area, the regional/metro area and use as a backbone network. For each of said areas of application there are self-contained network management systems, implemented in some cases by different technologies. The focus on particular manufacturers refers to the partly proprietary forms of realization of network management systems of the different individual manufacturers which are specifically tailored to products from a particular manufacturer and are often unsuitable for managing third-party telecommunications networks. The focus on traffic-related areas can be seen as the subdivision into voice and data networks.

The architecture of today's network management systems is characterized by communication structures between the individual network components in which the management functions are implemented by specifically-defined linked functionalities via specifically-provided program modules. These types of complex network management systems operate within a communications network as huge “monolithic blocks” which are difficult to operate and require a great deal of effort to maintain. Updating these types of complex network management system is a time-consuming process with which a high level risk of errors as well as financial outlay is associated. In addition expansion and scalability of these types of network management systems is difficult. Previously various technologies such as CORBA (“Common Object Request Broker Architecture”), RMI (“Remote Method Invocation”) and DCOM (“Distributed Component object Model”) have been used in communications networks for implementing communication between various network components via software components.

An abstract method for enabling network management systems to be embedded into the processes of the network provider is known from the publication “NGOSS Architecture Technology Neutral Specification”, TeleManagement FORUM, July 2001, P.26. This particularly describes an interface layout of network management systems required to guarantee a simple integration of the network management system functions into a network provider's system processes.

In addition a further approach to the description of interfaces of a “multi-technology and multi-vendor-capable” network management system is known from the publication “MULTI-Technology Network Management Business Agreement”, TeleManagement FORUM, August 2001, P. 7-9 in which the interfaces of a network management systems are described and defined on the basis of the CORBA-IDL (CORBA “Interface Definition Language”) technology. The CORBA-IDL technology is a standard for implementation-independent description of the syntax of an interface. The disadvantages of the approach described are the low flexibility of the CORBA-IDL technology used and the high level of maintenance required.

A network management system is known from U.S. Pat. No. 6,131,118 which enables the management of both hardware and software components of a communications network via a “client system”, for example a laptop with a Web browser. To provide this facility the network management system consists of a management server and a number of management elements, in which case the management elements are subdivided into Web-capable management elements and older management elements not capable of supporting Web technologies. The “Simple Management Protocol” (SNMP), the “Desktop Management Interface” (DMI) or similar management interfaces are provided as non-Web-capable management elements. By contrast the management elements with Web capabilities feature that are known as management agents with the aid of which the management data can be converted into a data format which can be transmitted over the conventional communications infrastructure of the World-Wide-Web (TCP/IP, URL, HTTP, TTML) and subsequently displayed in a Web browser of the client system. Furthermore the management agents feature a “managed element” communication layer in one or more servers. The “client system” supports the TCP/IP protocol and contains a Web browser for processing and displaying the management data of the management server of the Web-capable management elements.

Furthermore Web Services, i.e. network services, for business-to-business communication between various companies over the Internet are known which represent business, application or system functionalities. Web Services or service provision can be used for all types of “Web environments”, i.e. Internet, Intranet or Extranet. In such cases the-focus of communication is on business-to-business, business-to-consumer, department-to-department or peer-to-peer. Users of these types of Web Services or these types of service provisions can be human users who use the service with the aid of a browser either on a desktop PC or on a mobile computer. Users can also be further application programs or further Web services. These types of Web Services are largely provided by a “service provider”. A service provider in this context is taken to mean at least an available software package that can be called up via an application program provided this is registered for this service provision. The counterpart to the service provider is the “service requester”, who is looking for a specific Web Service or service provision and requesting this.

A particular requirement for operating a communications network is to be able to exchange the management data between the individual network components and the at least one network management system. Management data for example is typically understood as the data types defined under ITU-T M.3010. These relate to
Fault management,
Configuration management,
Accounting,
Performance monitoring and
Security management.

### SUMMARY OF INVENTION

The object of the invention is to specify an innovative method for operating a communications network which allows a reliable, non-proprietary and secure communication between the individual network components and at least one network management system.

The object is achieved by the claims.

The essential aspect of the method in accordance with the invention is to be seen in the fact that, the management data is exchanged via the communications infrastructure featuring different network protocols, service descriptions and service registrations provided by a Web service. This decouples the individual network components of a telecommunications network as regards their network management system and thus all network components can be managed via a central network management system in a platform-independent and non-proprietary way without the time-consuming and cost-intensive tailoring of the system to the different management interfaces being required. Furthermore use of Web Services for communication between the network components and the at least one network management system gives great flexibility with regard to opportunities for integrating network technologies and new “backend” applications into existing network management systems.

A further significant aspect of the method in accordance with the invention can be seen in the fact that the different network management functions are performed by different management system components. In addition the management data is exchanged between the management system components or various network management systems over the communications infrastructure available via the Web Service. The execution of the different network management functions by different management system components and the communication via the communications infrastructure provided by the Web Services between these management system components makes direct communication between all management system components possible. This decouples the individual management system components from the network management system as a whole and opens up their interfaces.

Advantageously at least one converter which converts the Web Service data format into the data format supported by the network component and vice versa is provided for network components which do not support communication via Web Services. Advantageously the converter in accordance with the invention maps the data of the network elements to Web Services or maps received Web Service data to data structures which can be processed by the network components. The converter then forwards the converted Web Service data to the connected network components. This adapts existing network management systems which support different communications interfaces to “Web Service-based” network management systems, in which case a high level of flexibility is achieved with regard to the “manageable” network components.

A further advantage of the invention can be seen in the fact that information about the description of the functions and the format of the parameters of each Web Service is stored in machine-readable form in at least one registry. Advantageously, by the provision of at least one registry, both new network functionalities and also new network components or network management components can be added without adversely affecting the existing network management system.

This type of implementation of new network management functions in existing communications networks and the associated network management system is easy to implement technically using Web Services and involves less financial outlay than network management systems implemented in accordance with the prior art. Further, by storing the information about the function description of each Web Service a network component is in a position to find the Web Services which are suitable for its desired application. Once these have been found, because the format of the parameters of the Web Services is in machine-readable form, the management data to be transferred to the network management system with the aid of the Web Services can be adapted to the format requirements of a Web Service.

An additional advantage of the method in accordance with the invention lies in the fact that information about the occurrence of network management processes as well as the events initiating them is stored in the registry on an ongoing basis and initiator-specific usage and interaction patterns are determined from the stored information. Using this as its starting point, new Web Services or a new Process Web Services consisting of the number of Web Services are formed by the at least one network management system. This allows the network management system to learn additional information and the spectrum of the network management functions is advantageously expanded or optimized with regard to individual network requirements.

Additional advantageous embodiments of the method in accordance with the invention can be found in the further claims.

The invention is explained in more detail below using suitable exemplary embodiments.

### BRIEF DESCRIPTION OF THE DRAWINGS

FIG. 1 shows a communications network with a network management system,

FIG. 2 also shows a communications network in which the layout of the communications infrastructure and the three communications processes are represented schematically,

FIG. 3 shows a communications process between a management system component and the registry,

FIG. 4 shows a communications process between a network component and the registry, and

FIG. 5 shows a communications process between a network component and the registry.

### DETAILED DESCRIPTION OF INVENTION

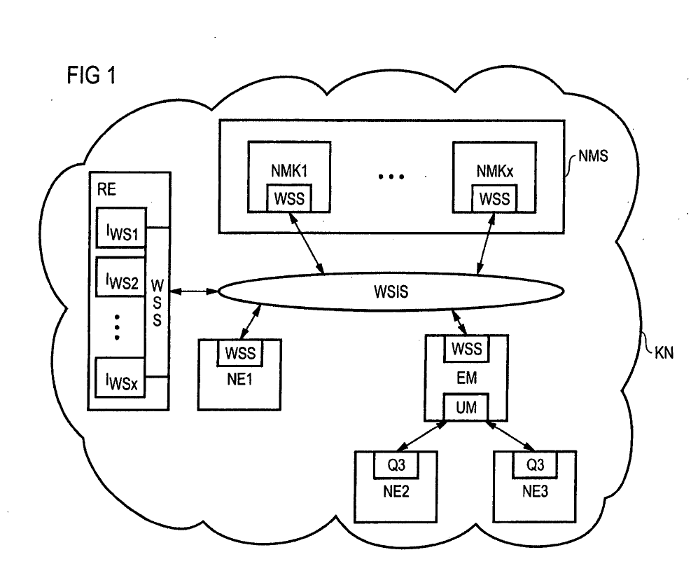

FIG. 1 shows a block schematic of a communications network KN which features a network management system NMS, a Registry RE, a first, second and third network element NE1, NE2, NE3 as well as an element manager unit or mediator unit EM. The network management system NMS, the Registry RE and also the first network element NE1 and the element manager unit EM are connected to each other via the communications infrastructure WSIS made available via the Web Service WS. The connection via the communications infrastructure WSIS of a Web Service WSS is shown in FIG. 1 using a gray oval WSIS and the corresponding Web Service interface WSS of the network management system NMS, the first network component NE1, the element manager unit EM as well as the Registry RE are indicated

In this case a converter UM is provided in the mediator unit or the element manager unit EM which converts the Web Service data format into the data format supported by the relevant network element and vice versa. In the exemplary embodiment shown in FIG. 1 the second and third network element NE2, NE3 for example do not feature any Web Service interface WSS but rather a Q3 interface. For communication between the second network element NE2 and the network management system NMS via the communications infrastructure WSIS for example the management data MD is converted by the converter UM from the Q3 data format into the XML data format supported by the Web Service and vice versa.

The network management system NMS features a first to xth management system component NMK1 to NMKx through which the different network management functions are implemented. To this end each of the first x management system components NMK1 to NMKX features a Web Service interface WSS for communication via the communications infrastructure WSIS of the Web Service WS. In a similar way—as already explained—the first network element NE1 and the element manager unit EM also feature a Web Service interface WSS. In the Registry RE first to xth Web Service information I_{WS1}, to I_{WSx} is stored which can retrieved via the Web service interface WSS of the network management system NMS arranged in the Registry RE or the first to third network element NE1, NE2, NE3 via the communications infrastructure WSIS made available by the Web Service WS. For reasons of clarity FIG. 1 only shows one example of a network management system NMS but in practice it is usual to provide a number of network management systems NMS.

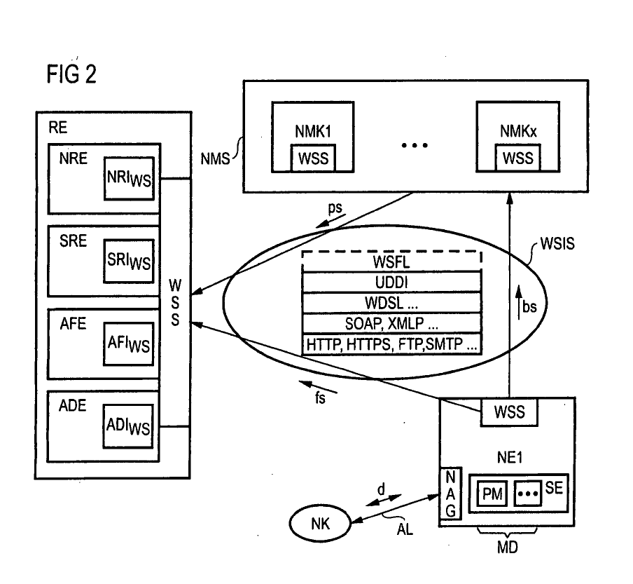

A communications process is described schematically on the basis of FIG. 2. In this case the network management system NMS is connected in a similar way to that shown in FIG. 1 via the communications infrastructure WSIS to the Registry RE and to the first network element NE1.

In the exemplary embodiment shown in FIG. 2 the Registry RE is subdivided, as regards the different functions executed by the Registry, into a Network Registry NRE, a Network Semantic Registry SRE, an Execution Unit AFE as well as an Adaptation Unit ADE. Stored in the network Registry NRE is registration information NRI_{WS} about the functionality of a registered Web Service WS, stored in the Network Semantic Registry SRE is semantic information SRI_{WS} about the functional description and the format of the parameters of each Web Service WS, stored in the Execution Unit AFE is execution information AFI_{WS} about the call sequence of a Web Service WS and stored in the Adaptation Unit ADE are initiator-specific application and interaction patterns ADI_{WS} for formation of new Web Services WS or Process Web Services PWS from a number of the existing Web Services WS in one or more memory units (not shown in FIG. 2)

Furthermore the communications infrastructure WSIS made available by a Web Service WS is shown in greater detail in FIG. 2 by breaking it down into different communications layers. For example a network protocol Layer (“HTTP”, “HTTPS”, “FTP”, “SMTP”), an XML messaging layer (“SOAP”, “XMLP” etc.), a service description layer (“WDSL” etc.) and also a service registration layer (“UDDI”) and a service workflow layer (“WSFL”) are shown in FIG. 2 The communications layers described represent the communications infrastructure WSIS for transmission of management data MD by a Web Service WS.

The three main procedural steps for operating the communications network KN on the basis of a network management task of performance data recording are explained in more detail below on the basis of the exemplary embodiment shown in FIG. 2.

The telecommunications system of a network customer NK is connected to the first network element NE1 via a network access device NAG as well as via an access line AL. In this case the network element NE1 can for example be embodied as an “IP router” or as an “SDH multiplexer”. In the first network element NE1 a memory unit SE is provided in which management data MD processed or determined in the first network element NE1 is stored.

The recording of the performance data PM determines information about the transmission quality of a connection and thereby about the quality of the service provided. To this end the continuous bit data stream D transmitted by the network customer NK via the access line AL to the network access device NAG is monitored in the network access device NAG and performance data PM is determined. This performance data PM or management data MD is stored in the memory unit SE of the first network element NE1. In this case the performance data PM is stored until such time as the memory capacity of the memory unit SE of the first network element NE1 is exceeded.

After the memory capacity of memory unit SE provided for this purpose is exceeded, in a first procedural step a search request fs is initialized by the first network element NE1 to the Registry RE, or rather to the Network Registry NRE, via the communications infrastructure WSIS, and information is searched for using this request about a Web Service WS registered in the Network Registry NRE, via which the performance data PM stored in the memory unit SE can be forwarded to the network management system NMS for further processing After registry information NRI_{WS} is found via a suitable functionality of one or more Web Services WS in the Network Registry NRE, semantics information SRI_{WS} about the function description and the format of the parameters of the selected Web Service WS is loaded by the first network element NE1 via the communications infrastructure WSIS from the Network Semantic Registry SRE. To this end the registry information NRI_{WS} is stored in the Network Registry NRE as well as the semantics information SRI_{WS} in the Network Semantic Registry SRI in machine-readable form. In addition information about the runtime behavior of each Web Service WS is stored in the Network Registry NRE. In this case an XML-based format, especially the Resource Description Framework (RDF) format is used as the storage format for machine-readable storage in the Registry RE. With the aid of this type of XML-based format the machine-readable information can easily be retrieved and evaluated by the individual network components NE1, NE2, NE3, EM.

A prerequisite for finding a Web Service in the Network Registry NRE of the Registry RE is the registration or storage of information of a new Web Service WS in the Registry RE by the network management system NMS. To this end the required information about the functionality, the runtime behavior, the function description and also the format of the parameters of the new Web Service WS is transmitted in a second procedural step by the management system components NMK1, . . . , NMKx made available to the Web Service WS with the aid of a “Publish” request ps to the Registry RE and stored in the different units of the Registry RE. This information is also transmitted using the communications infrastructure WSIS.

With the aid of the information transmitted by the Network Registry NRE as well as by the Network Semantic Registry SRE to the network element NE1 about the requested Web Service WS the supervision parameters PM stored in the network element NE1 are edited. In a third procedural step a “Bind” process bs is used via the communications infrastructure WSIS to bind the selected Web Services WS to the first network element NE1 and to transmit the edited performance data PM to the network management component NMK1 which is responsible for the bound Web Service WS.

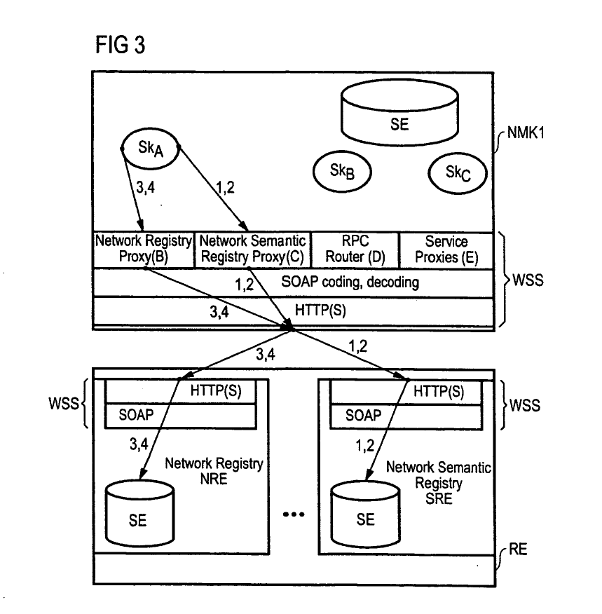

In FIG. 3 shows a schematic diagram with an example of a communications process for registering a Web Service WS between the first network management component NMK1 and the Network Registry NRE as well as the Network Semantic Registry SRE via the communications infrastructure WSIS of the relevant Web Service WS, corresponding to the second procedural step described above. In this case both the first management system component NMK1 and also the Network Registry NRE as well as the Semantic Registry SRE typically feature a memory unit SE to store the different management data MD. The blocks shown against a gray background in FIG. 3 are again elements of the communications infrastructure WSIS or provide the Web Service interface WSS of the relevant Web Service WS.

The first management system component NMK1 features a first, second and third subcomponent SK_{A}, SK_{B}, SK_{C} each of which implements different functions of the first network management component NMK1. Thus for example the first subcomponent SK_{A} is provided for publication of available Web Services in the Registry RE, the second subcomponent SK_{B} is provided for transfer of IP-related performance data IP-PM and the third subcomponent SK_{C} is provided for transfer of SDH-related performance data SDH-PM.

In the exemplary embodiment considered the first management system component NMK1 processes or evaluates the performance data. In a first step 1 the first subcomponent SK_{A} is started which checks the function description of the Web Services WS to be published for performance data processing in the Network Semantic Registry SRE. For this purpose a connection to the Network Semantic Registry SRE is established by the first subcomponent SK_{A} via the communications infrastructure WSIS, i.e. the “Network Semantic Registry Proxy (C)” layer as well as the “SOAP coding/decoding” layer and the “Http network protocol” layer. In the Network Semantic Registry SRE the first subcomponent SK_{A} accesses the memory unit SE via the “Http-network protocol” layer as well as the “SOAP coding/decoding” layer i.e. via the communications infrastructure WSIS made available by the Web Service WS. If the complete semantics information SRI_{WS} of the Web Services WS to be published is not yet stored in the memory unit SE of the Network Semantic Registry SRE then in a second step 2 the missing semantic information SRI_{WS} is published or stored in the Network Semantic Registry SRE by the first subcomponent SKA

This is followed in a third step 3 by the first subcomponent SK_{A} checking via the communications infrastructure of the Web Service WS whether the registration information NRI_{WS} of the Web Service WS to be published is stored in the Network Registry NRE. For this purpose a connection is established via the “Network registered Proxy (B)” layer, the “Soap coding/decoding” layer and also the “Http-network protocol” layer to the Network Registry NRE by the first subcomponent SK_{A}, in which like the Network Semantic Registry SRE there is access via the “Http network protocol” layer as well as the “Soap coding/decoding” layer to the memory unit SE. If registration information NRI_{WS} about the Web Service WS involved is missing, the first subcomponent SK_{A} stores the missing registration information NRI_{ws} in a fourth step 4 in the memory unit SE of the Network Registry NRE. By executing the four steps 1, 2, 3, 4 described the first subcomponent SK_{A} ensures the Web Service WS made available for performance data processing is sufficiently published in the communications network KN, i.e. sufficient information is available in machine readable form in the Network Registry NRE as well as the Network Semantic Registry NRE, SRE about the Web Service WS provided.

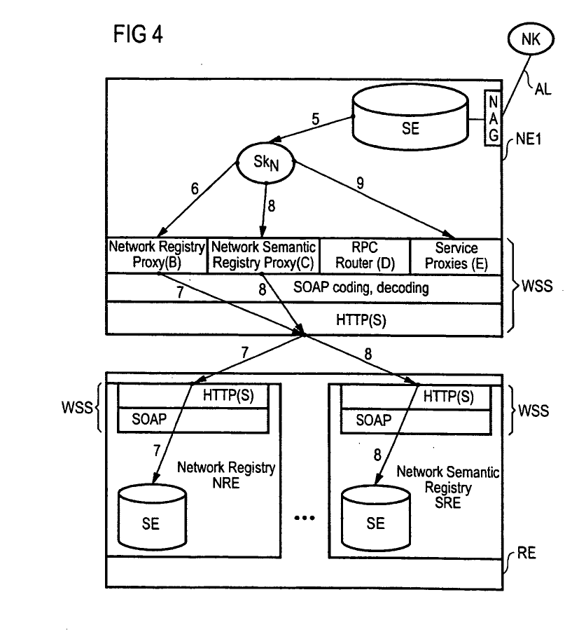

FIG. 4 shows an example of the second procedural step for operation of the communications network KN. For this FIG. 1 shows the first network element NE1 as well as the Registry RE, where the first network element NE1 is a memory unit SE as well as an Nth subprocedure SK_{N} for forwarding the performance data PM to the network management system NMS.

With reference to FIG. 4 the further steps 5, . . . ,9 are explained which are required to find through the first network element NE1 a Web Service WS suitable for the network management process to be executed in the Registry RE. In the first network element NE1, which could be an “Internet protocol router” for example, the performance data PM determined in the network access device NAG is recorded and stored and in the memory unit SE. As soon a predefined memory overflow level is exceeded by the amount of stored performance data PM in the memory unit SE, this overflow is indicated in a fifth step 5 of the Nth subprocedure SK_{N}. This is followed, in a sixth step 6 by the Nth subprocedure SK_{N} sending a search inquiry fs to the Registry RE. This is done by the Nth subprocedure SK_{N} establishing a connection via the communications infrastructure WSIS, i.e. the “Network Registry Proxy (B)”, the “Soap coding/decoding” as well as the “Http network protocol” to the Network Registry RE. Via the connection, in a seventh step 7 by the Nth subprocedure SK_{N} searching through the registration information NRI_{WS} stored in the Network Registry NRE with regard to a Web service stored for processing of performance data PM and after finding registration information NRI_{WS}, in an eighth step 8, establishing of a connection via the Web Service WS by the Nth subprocedure SKN to the Network Semantic Registry SRE. The connection is established in this case via the “Network Semantic Proxy (C)”, the “SOAP coding/decoding” and the “Http network protocol”. Subsequently the interface description of the Web Service WS, i.e. the semantics information SRI_{WS} about the form of the parameters of the relevant Web Service WS is transmitted via the connection established to the Nth subprocedure SK_{N}. With the aid of the registration information NRI_{WS} received about the runtime behavior as well as the function description as well as the semantics information SRI_{WS} about the form of the parameters of the selected Web Services WS a “Web Service Proxy (E)” interface is formed in the first network element NE1 which is based on the existing communications infrastructure WSIS.

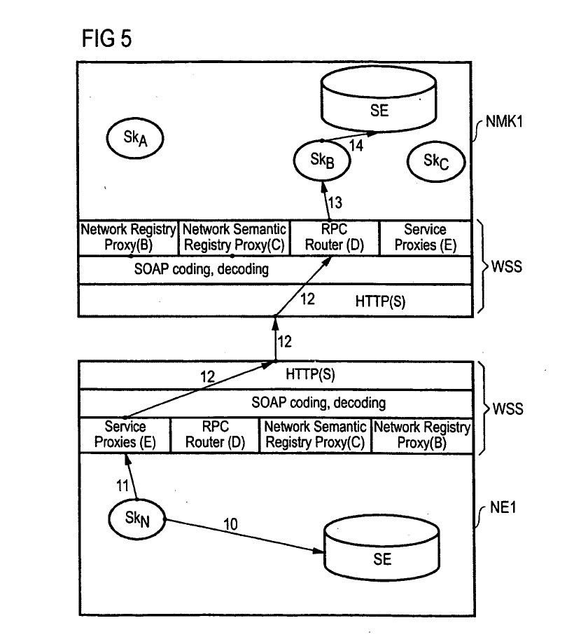

The third procedural step for assigning a selected Web Service WS to the first network element NE1 on the basis of a “bind” process bs is described in more detail with reference to FIG. 5. In this case the first management system component NMK1 communicates with the first network element NE1 via the communications infrastructure WSIS made available by the selected Web Service WS.

The first management system component NMK1 features a memory unit SE as well as the first second and third subcomponent SK_{A}, SK_{B}, SK_{C}. The first network element NE1 features the Nth subprocedure SKN as well as a memory unit SE. After the Web Service WS for transfer of the performance data PM from the first network element NE1 to the responsible first management system component NMK1 has been found, in a tenth step 10 the Nth subprocedure SKN in the first network element NE1 loads the performance data PM from the memory unit SE. In an eleventh step 11 the performance data PM is then transferred by the Nth subprocedure SKN to the previously formed “Service Proxy (E)” interface, which represents an element of the communications infrastructure WSIS of the selected Web Service WS. The description of the selected Web Service WS, of which it represents the proxy, is then determined by the “ServiceProxy (E)” interface. The performance data PM transferred by the Nth subprocedure SKN is edited by the “Service-Proxy (E)” interface so that the edited performance data PM has the required format of the parameters for using the selected Web Services WS. For example, in accordance wit the RDF definition the “Service-Proxy (E)” interface generates an XML file from the performance data PM and then concatenates the content of the XML file into a data string. The data string is transferred in a twelfth step 12 via the Service Proxy (E) interface to the IP addresses found, for example http://powerTelco.intranet/network/pm-data/consumption, of the selected Web Service WS which are stored in the management system component NMK1. For this purpose communication is established via the “RPC router (D)” layer with the second subcomponent SK_{B}.

In the exemplary embodiment illustrated only one management system component NMK1 is shown. Further management system components NMKx which perform the same management function as the first network management component NMK1 and are thereby provided as redundant components, are not included in the exemplary embodiment examined.

The performance data PM is received from the first management system component NMK1 via the “RPC router (D)” layer and, as already explained, forwarded in a thirteenth step 13 to the second subcomponent SK_{B}. Here the “RPC-Router (D)” layer is given the task of forwarding the performance data PM to the subcomponent SK_{B},SK_{C} which is provided for processing of the data type of the performance data monitoring, i.e. for example in the exemplary embodiment considered here, to the second subcomponent SK_{B} responsible for monitoring of Internet protocol performance data. The second subcomponent SK_{B} evaluates the received performance data PM and stores the evaluation results in a fourteenth step 14 in the memory unit SE.

The Web Service WS for performance data processing stored in FIG. 3 to 5 only represents one example of a specific network management process. The method in accordance with the invention can be applied in a similar fashion to all network management processes to be undertaken within a communications network.

The adaptation unit ADE provided in the Registry RE stores information on an ongoing basis about the occurrence of network management processes and the events initiating them, for example alarms, from which usage and interaction patterns specific to the initiator are determined. Using the initiator-specific usage and interaction patterns determined, the network management system NMS uses feedback or self-improvement techniques to form new Web Services WS or Process Web Services PWS assembled from a number of known Web Services WS. This makes it possible for the network management system functionalities to be expanded automatically and for the network management system NMS to be adapted to individual customer-specific events.

1-18. (cancelled)

19. A method for operating a communications network, the communications network comprising a network management system and a plurality of network components, the method comprising:
providing a communications infrastructure by a Web Service;
providing different network protocols, service descriptions and service registrations by the communications infrastructure; and
exchanging management data between the management system and a network component via the communications infrastructure.

20. The Method according to claim 19, wherein
different network management functions are performed by different management system components.

21. The Method according to claim 19, further comprising:
exchanging management data between individual management system components or different network management systems via the communications infrastructure available via the Web Service.

22. The Method according to claim 19, further comprising:
providing, for network components which do not support communication via Web Services, at least one converter which converts the Web Service data format into the data format supported by the network component and vice versa.

23. The Method according to claim 19, further comprising:
storing in at least one registry information about the function description and the format of the parameters of each Web Service in machine-readable form.

24. The Method according to claim 19, further comprising:
storing additional information about the functionality and the runtime behavior of each Web Service in machine-readable form.

25. The Method according to claim 19, further comprising:
selecting for implementation of a network management process, a network component or a management system component of the stored Web Services; and
forwarding on the basis of the Registry stored information about the selected Web Service the management data to be determined via the communications infrastructure made available by the selected Web Service to a management system component.

26. A Method according to claim 19, further comprising:
determining for implementation of a network management process by a network component or a management system component the Web Services stored in the Registry for implementing the network management process;
selecting one or more of the stored Web Services; and
forwarding, on the basis of the information stored in the Registry via the selected Web Service, the management data to be transferred via the communications infrastructure, made available by the selected Web Service, to a management system component.

27. The Method according to claim 19, wherein
selecting a Web Service is done by evaluating a function description.

28. The Method according to claim 19, wherein
the information about the functionality, the runtime behavior, the function description and the format of the parameters of each Web Service is stored in the Registry in an XML-based format, especially the Resource Description Framework format.

29. The Method according to claim 19, further comprising:
forming for processing complex network management procedures, a Process Web Service from a number of Web Services which can be called up using the Web Service Flow Language or using the DARPA-Agent Markup Language Services or using a service based on these.

30. The Method according to claim 19, further comprising:
storing information about the occurrence of network management processes as well as the events initiating them in the Registry on an ongoing basis,
determining initiator-specific usage and interaction patterns from the stored information; and,
forming, based on this, by the at least one network management system, new Web Services or Process Web Server consisting of one or more Web Services.

31. The Method according to claim 19, wherein
the Process Web Services from the initiator-specific application and Interaction patterns are formed with the aid of feedback techniques or self-improvement techniques.

32. The Method according to claim 19, wherein
the different functions of the Registry are performed by a Network Registry, a Network Semantic Registry, an Execution Unit as well as an Adaptation Unit.

33. The Method according to claim 19, wherein
a network component is realized by a network element or by an element manager unit or by a mediator unit.

34. The Method according to claim 19, further comprising:
providing XML messaging or service workflow as an additional communications infrastructure by a Web Service.

35. The Method according to claim 19, further comprising:
operating the at least one network management system by the user using an adaptive graphical user interface.

36. A Method for operating a communications network which features at least one network management system and a number of network components, the method comprising:
exchanging data between the network management system and a network component management via a communications infrastructure made available by a Web Service and featuring different network protocols, service descriptions and service registrations; and
exchanging management data between individual management system components or different network management systems via the communications infrastructure available via the Web Service, wherein
different network management functions being performed by different management system components.

37. A Method for operating a communications network, the communications network comprising a network management system and a plurality of network components, the method comprising:
exchanging management data between the management system and a network component;
providing a communications infrastructure by a Web Service;
providing different network protocols, service descriptions and service
registrations by the Web Service; and
exchanging management data via the communications infrastructure; and
providing, for network components which do not support communication via Web Services, at least one converter which converts the Web Service data format into the data format supported by the network component and vice versa,
wherein different network management functions are performed by different management system components.
